(19) United States
(12) Patent Application Publication
(10) Pub. No.: US 2026/0004296 A1
(43) Pub. Date: Jan. 1, 2026

(54) SYSTEMS AND METHODS FOR BYPASSING CONTACTLESS PAYMENT TRANSACTION LIMIT

(71) Applicant: Capital One Services, LLC, McLean, VA (US)

(72) Inventors: Abdelkader BENKREIRA, Washington, DC (US); Brendan WAY, Brooklyn, NY (US); Tyler MAIMAN, Melville, NY (US)

(21) Appl. No.: 19/235,123

(22) Filed: Jun. 11, 2025

Related U.S. Application Data
(63) Continuation of application No. 17/882,879, filed on Aug. 8, 2022.

(51) Int. Cl. G06Q 20/40; G06Q 20/34

(52) U.S. Cl. CPC G06Q 20/4015; G06Q 20/352; G06Q 20/405

(57) ABSTRACT

Example embodiments of systems and methods for a cryptographic bypass system, comprising: a contactless card; and a server, wherein the server is configured to: receive a cryptogram and location data after a tap of the contactless card to a client device, identify a first merchant based on the location data, set a flag associated with the first merchant and the contactless card, receive a transaction request from a merchant payment system of the first merchant associated with the contactless card, wherein the transaction request indicates a transaction amount, and approve the transaction request when the transaction amount exceeds a first transaction limit when the flag is set.

### CROSS-REFERENCE TO RELATED APPLICATION

The present application is a continuation of U.S. patent application Ser. No. 17/882,879, filed Aug. 8, 2022, the contents of which incorporated herein by reference in their entirety.

### FIELD OF THE INVENTION

The present disclosure relates to a cryptographic bypass system, and more particularly, to systems and methods for the bypassing a transaction limit using a contactless payment instrument and a mobile device.

### BACKGROUND

Most modern payment instrument issuers employ security protocols to reduce the risk that their customers payment card has not been stolen, or otherwise compromised. For example, issuers can impose a transaction limit at particular merchants, and prevent any transaction requests from being processed above the transaction limit. Such protocols, however, require a customer to contact their bank, usually by telephone, to lift the transaction limit so they are authorized to utilize their payment instrument to execute the transaction request (which exceeded the customer's transaction limit). The customer must answer security questions over the phone to authenticate themselves, and provide minute details about their desired transaction and the merchant involved in the transaction.

Such conventional approaches, however, can be overly burdensome for customers. This can result in a diminished customer experience and a reduction in completed transactions.

These and other deficiencies exist. Accordingly, there is a need to provide users with an appropriate solution that overcomes these deficiencies to provide an efficient and easy to use mechanism for bypassing issuer imposed transaction limits.

### SUMMARY

Aspects of the disclosed technology include systems and methods for cryptographic authentication of contactless cards. Various embodiments describe systems and methods for implementing and managing cryptographic authentication of contactless cards.

### BRIEF DESCRIPTION OF THE DRAWINGS

FIG. 1 is a diagram of a data transmission system according to an example embodiment.

FIG. 2 is a diagram illustrating a sequence for providing authenticated access according to an example embodiment.

FIG. 3 illustrates a system using a contactless card according to an example embodiment.

FIG. 4A illustrates a contactless card according to an example embodiment.

FIG. 4B illustrates a contact pad of the contactless card according to an example embodiment.

FIG. 5 illustrates an exemplary client device side transaction limit process according to an example embodiment.

FIG. 6 illustrates an exemplary issuer server transaction limit process according to an example embodiment.

FIG. 7 is a diagram illustrating a sequence in an exemplary transaction limit bypass process described herein according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

An objective of some embodiments of the present disclosure is to cryptographic bypass system for the bypassing a transaction limit using a contactless payment instrument and mobile device. In these embodiments, a user can performing a tap or other gesture with a contactless card to a client device (such as a mobile device) to facilitate an efficient authentication communication, in which a server identifies a merchant, based on, for example, Global Position System (GPS) coordinates of the client device and merchant geofences, and transmits to the client device a request for the user to exceed a transaction limit at the particular merchant, which can be displayed by the client device. The user can then readily enable the transaction limit to be exceeded by interacting with the client device which displays a selectable option for the user to exceed the transaction limit.

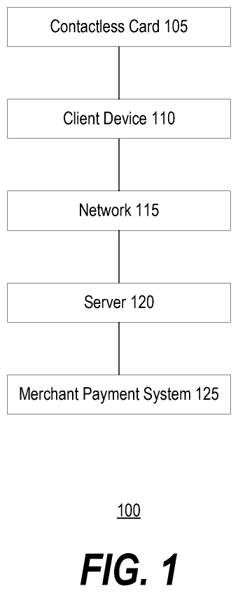

FIG. 1 illustrates a data transmission system according to an example embodiment. As further discussed below, system 100 may include contactless card 105, client device 110, network 115, server 120, and merchant payment system 125. Although FIG. 1 illustrates single instances of the components, system 100 may include any number of components.

System 100 may include one or more contactless cards 105. In some embodiments, contactless card 105 may be in wireless communication, utilizing near field communication (NFC) as an example, with client device 110, network 115, and server 120.

System 100 may include client device 110, which may be a network-enabled computer. As referred to herein, a network-enabled computer may include, but is not limited to a computer device, or communications device including, e.g., a server, a network appliance, a personal computer, a workstation, a phone, a handheld PC, a contactless card, a personal digital assistant, a thin client, a fat client, an Internet browser, or other device. Client device 110 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 110 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 110 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 110 of system 100 may execute one or more applications, such as software applications, that enable, for example, network communications with one or more components of system 100 and transmit and/or receive data.

Client device 110 may be in communication with one or more servers 120 via one or more networks 115, and may operate as a respective front-end to back-end pair with server 120. Client device 110 may transmit, for example from a mobile device application executing on client device 110, one or more requests to server 120. The one or more requests may be associated with retrieving data from server 120. Server 120 may receive the one or more requests from client device 110. Based on the one or more requests from client device 110, server 120 may be configured to retrieve the requested data from one or more databases (not shown). Based on receipt of the requested data from the one or more databases, server 120 may be configured to transmit the received data to client device 110, the received data being responsive to one or more requests.

System 100 may include one or more networks 115. In some examples, network 115 may be one or more of a wireless network, a wired network or any combination of wireless network and wired network, and may be configured to connect client device 110 to server 120. For example, network 115 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 115 may include, without limitation, telephone lines, fiber optics, IEEE Ethernet 902.3, a wide area network, a wireless personal area network, a LAN, or a global network such as the Internet. In addition, network 115 may support an Internet network, a wireless communication network, a cellular network, or the like, or any combination thereof. Network 115 may further include one network, or any number of the exemplary types of networks mentioned above, operating as a stand-alone network or in cooperation with each other. Network 115 may utilize one or more protocols of one or more network elements to which they are communicatively coupled. Network 115 may translate to or from other protocols to one or more protocols of network devices. Although network 115 is depicted as a single network, it should be appreciated that according to one or more examples, network 115 may comprise a plurality of interconnected networks, such as, for example, the Internet, a service provider's network, a cable television network, corporate networks, such as credit card association networks, and home networks.

System 100 may include one or more servers 120. In some examples, server 120 may include one or more processors, which are coupled to memory. In some examples, server 120 may be a network-enabled computer. Server 120 may be configured as a central system, server or platform to control and call various data at different times to execute a plurality of workflow actions. Server 120 may be configured to connect to the one or more databases. Server 120 may be connected to at least one client device 110.

System 100 may include one or more merchant payment system 125. In some embodiments, merchant payment system can include a merchant point of sale device (POS), that the customer can interact with via their contactless card 105. The merchant payment system can incorporate various technologies, including technologies for receiving information from the contactless card when the customer seeks to effectuate a transaction, and submitting transaction requests to the one or more servers 120, and in some embodiments, includes a processor, memory, a chip reader, a network interface, and other components.

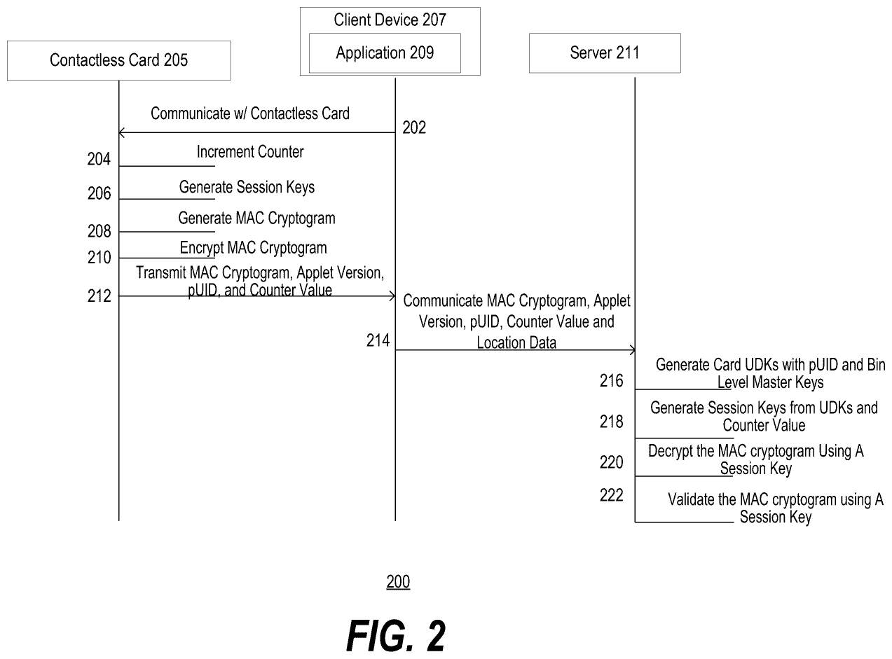

FIG. 2 is a timing diagram illustrating an example sequence for providing authenticated access according to one or more embodiments of the present disclosure. System 200 may comprise contactless card 205, client device 207, which may include an application 209, and a server 211.

At step 202, the application 209 communicates with the contactless card 205 (e.g., after being brought near the contactless card 205). Communication between the application 209 and the contactless card 205 may involve the contactless card 205 being sufficiently close to a card reader (not shown) of the client device 207 to enable NFC data transfer between the application 209 and the contactless card 205.

At step 204, a counter value that is maintained by the contactless card can be updated or incremented. The counter value may comprise a number that changes each time the contactless card enters a communication field (e.g., an NFC field generated by the client device 207), each time data is exchanged between the contactless card 205 and the client device 207, and/or each time a transaction involving the contactless card 205 takes place.

At step 206, two session keys can be generated, and one of the session keys can be used, with the counter value, to generate a message authentication code (MAC) cryptogram and the other session key can be used to encrypt the MAC cryptogram as described further herein. In some examples, one or more cryptographic algorithms can be used. Exemplary cryptographic algorithms can include, without limitation, a MAC algorithm, a hash-based message authentication code (HMAC) algorithm, a cipher-based message authentication code (CMAC) algorithms, the 3DES algorithm, a symmetric HMAC algorithm, and a symmetric CMAC algorithm. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

At step 208, the contactless card 205 can generate a MAC cryptogram using the card's unique ID number (pUID), a shared secret (which is known by both the contactless card and the server), and/or applet version (which can indicate a version of the applet, the software, used on the contactless card), with one of the two session keys. At step 210 the contactless card 205 can encrypt the MAC cryptogram using the other session key.

To illustrate steps 202, 204, 206, 208, and 210 a reader, such as application 122, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 105 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string).

At step 212, the contactless card 205 sends the MAC cryptogram to the application 209 as well as the applet version, pUID and counter value. In some examples, the transmission of occurs via NFC, however, the present disclosure is not limited thereto. In other examples, this communication may occur via Bluetooth, Wi-Fi, or other means of wireless data communication.

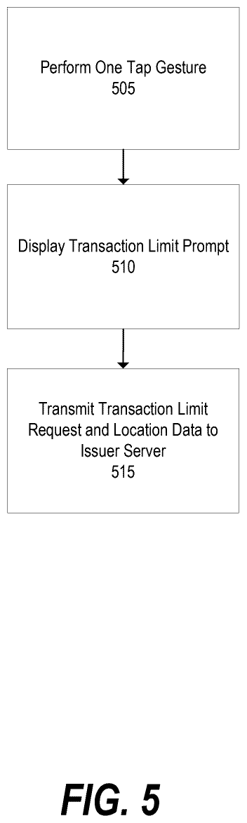

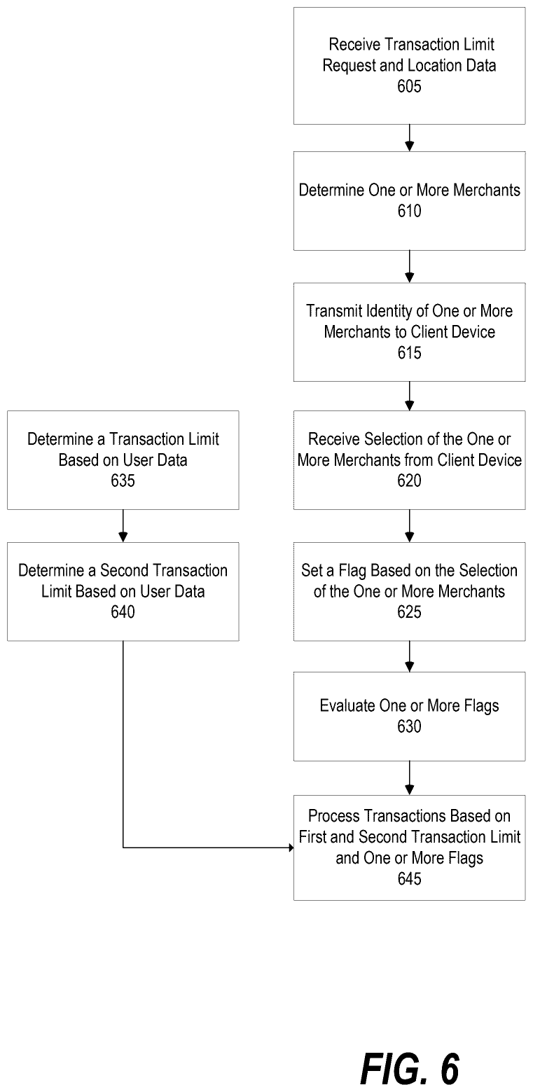

At step 214, the application 209 communicates the MAC cryptogram to the server 211 as well as the applet version, pUID and counter value. The application can also transmit other information, such as location data (indicating the location of client device, which is describe in further detail with respect to FIGS. 5 and 6).

At step 216, the server 211 generates card unique derived keys (UDK) with the pUID and bin-level master keys.

At step 218 the server 211 can generate session keys from the UDKs (generated in step 214) and the counter value.

At step 220 the server can decrypt the MAC cryptogram.

At step 222 the server can validate the MAC cryptogram based on the pUID, counter, and the shared secret, using the session key.

In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

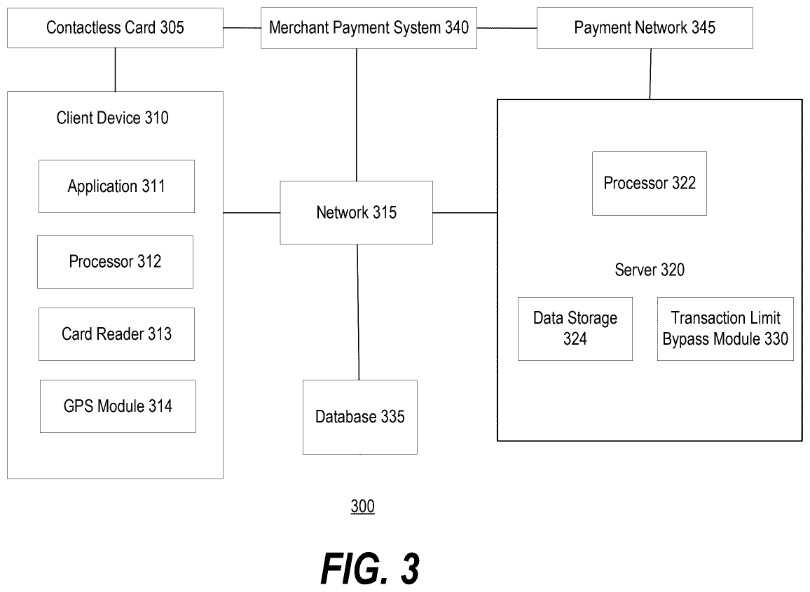

FIG. 3 illustrates a system 300 using a contactless card. System 300 may include a contactless card 305, one or more client devices 310, network 315, one or more servers 320, one or more databases 335, one or more merchant point of sale (POS) devices, and one or more payment networks 345. Although FIG. 3 illustrates single instances of the components, system 300 may include any number of components.

System 300 may include one or more contactless cards 305. In some examples, contactless card 305 may be in wireless communication, for example NFC communication, with client device 310. For example, contactless card 305 may comprise one or more chips, such as a radio frequency identification chip, configured to communication via NFC or other short-range protocols. In other embodiments, contactless card 305 may communicate with client device 310 through other means including, but not limited to, Bluetooth, satellite, Wi-Fi, wired communications, and/or any combination of wireless and wired connections. Contactless card 305 may comprise one or more microprocessors and one or more memories configured to store or more software applications or applets (e.g., Java Card applets) configured to execute on cards and perform the functions and operations described herein.

According to some embodiments, contactless card 305 may be configured to communicate with card reader 313 of client device 310 through NFC when contactless card 305 is within range of card reader 313. In other examples, communications with contactless card 305 may be accomplished through a physical interface, e.g., a universal serial bus interface or a card swipe interface.

System 300 may include client device 310, which may be a network-enabled computer. As referred to herein, a network-enabled computer may include, but is not limited to: e.g., a computer device, or communications device including, e.g., a server, a network appliance, a personal computer, a workstation, a mobile device, a phone, a handheld PC, a contactless card, a personal digital assistant, a thin client, a fat client, an Internet browser, or other device. One or more client devices 310 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone or like wearable mobile device. In some examples, the client device 310 may be the same as, or similar to, a client device 110 as described with reference to FIG. 1 or FIG. 2 and the client device 301 described with reference to FIG. 3.

Client device 310 may be in communication with one or more servers via one or more networks 315. Client device 310 may transmit, for example from an application 311 executing on client device 310, one or more requests to one or more servers 320. The one or more requests may be associated with retrieving data from server 320. Server 320 may receive the one or more requests from client device 310. Based on the one or more requests from client device 310, server 320 may be configured to retrieve the requested data from one or more databases 335. Based on receipt of the requested data from the one or more databases 335, the server 320 may be configured to transmit the received data to client device 310, the received data being responsive to one or more requests.

Client device 310 can further include a GPS module 314, which can be configured to ascertain the location of the client device 310. In some embodiments, the location of the client device 310 can be the GPS coordinates of the client device

System 300 may include one or more networks 315. In some examples, network 315 may be one or more of a wireless network, a wired network or any combination of wireless network and wired network, and may be configured to connect client device 310 to server 320 and 325. For example, network 315 may include one or more of a fiber optics network, a passive optical network, a cable network, a cellular network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, RFID, Wi-Fi, and/or any combination of networks thereof. As a non-limiting example, communications from contactless card 305 and client device 310 may comprise NFC communication, cellular network between client device 310 and a carrier, and Internet between the carrier and a back-end.

In addition, network 315 may include, without limitation, telephone lines, fiber optics, IEEE Ethernet 902.3, a wide area network, a wireless personal area network, a local area network, or a global network such as the Internet. In addition, network 315 may support an Internet network, a wireless communication network, a cellular network, or the like, or any combination thereof. Network 315 may further include one network, or any number of the exemplary types of networks mentioned above, operating as a stand-alone network or in cooperation with each other. Network 315 may utilize one or more protocols of one or more network elements to which they are communicatively coupled. Network 315 may translate to or from other protocols to one or more protocols of network devices. Although network 315 is depicted as a single network, it should be appreciated that according to one or more examples, network 315 may comprise a plurality of interconnected networks, such as, for example, the Internet, a service provider's network, a cable television network, corporate networks, such as credit card association networks, and home networks.

In various examples according to the present disclosure, client device 310 of system 300 may execute one or more applications 311, and include one or more processors 312. For example, one or more applications 311, such as software applications, may be configured to enable, for example, network communications with one or more components of system 300 and transmit and/or receive data. It is understood that although only single instances of the components of client device 310 are illustrated in FIG. 3, any number of devices 310 may be used. Card reader 313 may be configured to read from and/or communicate with contactless card 305. In conjunction with the one or more applications 311, card reader 313 may communicate with contactless card 305.

The application 311 of any of client device 310 may communicate with the contactless card 305 using short-range wireless communication (e.g., NFC). The application 311 may be configured to interface with a card reader 313 of client device 310 configured to communicate with a contactless card 305. As should be noted, those skilled in the art would understand that a distance of less than twenty centimeters is consistent with NFC range.

In some embodiments, the application 311 communicates through an associated reader (e.g., card reader 313) with the contactless card 305.

In some embodiments, card activation may occur without user authentication. For example, a contactless card 305 may communicate with the application 311 through the card reader 313 of the client device 310 through NFC. The communication (e.g., a tap of the card proximate the card reader 313 of the client device 310) allows the application 311 to read the data associated with the card and perform an activation. In some cases, the tap may activate or launch application 311 and then initiate one or more actions or communications with an account server 325 to activate the card for subsequent use. In some cases, if the application 311 is not installed on client device 310, a tap of the card against the card reader 313 may initiate a download of the application 311 (e.g., navigation to an application download page). Subsequent to installation, a tap of the card may activate or launch the application 311, and then initiate (e.g., via the application or other back-end communication) activation of the card. After activation, the card may be used in various transactions including commercial transactions.

According to some embodiments, the contactless card 305 may include a virtual payment card. In those embodiments, the application 311 may retrieve information associated with the contactless card 305 by accessing a digital wallet implemented on the client device 310, wherein the digital wallet includes the virtual payment card. In some examples, virtual payment card data may include one or more static or dynamically generated virtual card numbers.

According to some embodiments, information about the client device 310 and client device 310 can be transmitted by the application 311 to the server 320 via the network 315. The information can include a type of client device 310 and client device 310, which can be ascertained by the systems and methods described herein.

Server 320 may comprise a web server in communication with database 335. In some examples, server 320 may be configured to validate one or more credentials from contactless card 305 and/or client device 310 by comparison with one or more credentials in database 335. Server 325 may be configured to authorize one or more requests, such as payment and transaction, from contactless card 305 and/or client device 310.

Server 320 can include processor 322, data storage 324, and transaction limit bypass module 330. processor 135, which can be a central processing unit (CPU), which can be configured to execute computer program instructions to perform various processes and methods. The at least one CPU can comprise several processors, a single processor, or a single device having multiple processors.

Data storage 324 can be for example, random access memory (RAM) and read only memory (ROM), which can be configured to access and store data and information and computer program instructions. The data storage can also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files can be stored. The data storage of the network-enabled computer systems can include electronic information, files, and documents stored in various ways, including, for example, a flat file, indexed file, hierarchical database, relational database, such as a database created and maintained with software from, for example, Oracle® Corporation, Microsoft® Excel® file, Microsoft® Access® file, a solid state storage device, which can include an all flash array, a hybrid array, or a server-side product, enterprise storage, which can include online or cloud storage, or any other storage mechanism.

The data storage 324 can be a read-only memory, write-once read-multiple memory or read/write memory, e.g., RAM, ROM, and EEPROM, and the server 320 can include one or more of these memories. A read-only memory can be factory programmable as read-only or one-time programmable. One-time programmability provides the opportunity to write once then read many times. A write once/read-multiple memory can be programmed at a point in time after the memory has left the factory. Once the memory is programmed, it cannot be rewritten, but it can be read many times. A read/write memory can be programmed and re-programed many times after leaving the factory. It can also be read many times.

Although depicted as single elements, it should be appreciated that according to one or more embodiments, the server 320 can comprise a plurality of data storage components 324 and processors 322, and other components, such as a communications interface (not shown). The components can be combined, integrated, separated, or duplicated to support various applications. Also, a function described herein as being performed at a particular component can be performed at one or more other components and by one or more other devices instead of or in addition to the function performed at the particular component. Further, the components can be implemented across multiple devices or other components local or remote to one another. Additionally, the components can be moved from one device and added to another device, or can be included in both devices.

Server 320 can also include transaction limit bypass module 330. Transaction limit bypass module 330 can, for example, identify one or more merchants based on location data and based on user selection of an identified merchant, can determine a first and second transaction limit, and a transaction bypass limit period, can set flags to indicate whether a transaction limit bypass is set for a particular merchant and contactless card, and can prevent transactions occurring exceeding the first or second transaction limit based on whether an associated flag is set.

In some embodiments, the transaction limit bypass module 330 can utilize predictive models to determine a first and second transaction limit, and a transaction limit bypass period. The first transaction limit can be, for example, a normal transaction limit that is imposed to prevent transaction requests exceeding certain transaction amounts without the user requesting a transaction limit bypass for a particular merchant. A second transaction limit can be an elevated transaction amount, greater than the first transaction limit, that can prevent transactions requests exceeding the second transaction request after a user requests a transaction limit bypass. The transaction limit bypass period is the time period in which the first transaction limit can be exceeded for a particular merchant. In some embodiments, the transaction limit bypass module 330 can make predictions of the first and second transaction limit amounts and period of time of the transaction limit bypass period using one or more of the predictive models described herein. In other embodiments, the transaction bypass module 330 can set a predefined time in which the first transaction limit can be exceed.

One or more predictions by the transaction limit bypass module 330 can be developed by one or more machine learning algorithms and generated by the application of by one or more predictive models. In an embodiment, the machine learning algorithms employed can include at least one selected from the group of gradient boosting machine, logistic regression, neural networks, and a combination thereof, however, it is understood that other machine learning algorithms can be utilized.

For example, to generate predictions, one or more predictive models can utilize parameters such as user data and merchant data. User data can include, for example, previous user transactions, financial information of the user (account balance, credit history, income etc.), data indicative of the time taken for a particular user to conduct a transaction once entering a store, or after having set a transaction limit bypass request. User data can also include user preferences set by the user as how long to allow a particular flag to be set after the user performs a transaction limit bypass request. Merchant data can include information pertaining to the average transaction amount for a typical merchant for a plurality of customers, data indicative of the transaction amount of fraudulent transactions at a particular vendor, and the trustworthiness of the merchant, data indicative of an average time that a plurality of customers take to perform a certain transaction for a given merchant after request a transaction limit bypass request.

The predictive models described herein can utilize various neural networks, such as convolutional neural networks (“CNNs”) or recurrent neural networks (“RNNs”), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that cannot be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (“LSTMs”) and gated recurrent units

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

Exemplary embodiments may utilize a training set comprising the following parameter including, for example, merchant data and user data for determining a transaction limit and transaction limit period as described further herein. User data can data indicative of previous transactions of the user (such as average transaction volume and transaction frequency of the user, whether the user typically transacts with a particular merchant, an amount of a typical transaction, and an amount of a typical transaction of a particular type of merchant) and other financial information of the user, such as a the user's credit score, account balance, annual salary, and other user specific metrics relevant a transaction limit. Merchant data can further include information pertaining to the average transaction amount for a typical merchant for a plurality of customers, fraudulent transaction amounts for a particular merchant, and the trustworthiness of the merchant.

The server 320 can have differentiated access to other third party systems (such as systems of banking and other financial entities), including public data source systems via private APIs. The server 320 can also have differentiated access to client devices (e.g., the client devices 310) via private device APIs. The server 320 can make calls to the private APIs utilizing a token to provide a secure communication channel between the server 320 and other third party systems. The device APIs can also provide a secure communication between the client device 310 and the server 320.

System 300 can further include a merchant payment system 340 used to facilitate transactions between a user (via their contactless card 305) and the merchant associated with the merchant payment system. Merchant payment system 340 can include a point of sale (POS) system, including a debit/credit card reader and processing system that transmits transaction requests to a payment sever (such as server 320) via a payment network 345. In the case of communications between the merchant payment system 340 and the server 320, the payment network 345 can be the automated clearing house (ACH) network and/or similar kinds of networks. Merchant payment system 340 can include the hardware and software necessary for facilitating transactions between server 325 and a user's contactless card 305 via payment network 345 and/or network 315.

Example embodiments of systems and methods described herein may be configured to provide security factor authentication. The security factor authentication may comprise a plurality of processes. As part of the security factor authentication, a first process may comprise logging in and validating a user via one or more applications executing on a device. As a second process, the user may, responsive to successful login and validation of the first process via the one or more applications, engage in one or more behaviors associated with one or more contactless cards. In effect, the security factor authentication may include both securely proving identity of the user and engaging in one or more types of behaviors, including but not limited to one or more tap gestures, associated with the contactless card. In some examples, the one or more tap gestures may comprise a tap of the contactless card by the user to a device. In some examples, the device may comprise a mobile device, a kiosk, a terminal, a tablet, or any other device configured to process a received tap gesture.

In some examples, the contactless card may be tapped to a device, such as one or more computer kiosks or terminals, to verify identity so as to receive a transactional item responsive to a purchase, such as a coffee. By using the contactless card, a secure method of proving identity in a loyalty program may be established. Securely proving the identity, for example, to obtain a reward, coupon, offer, or the like or receipt of a benefit is established in a manner that is different than merely scanning a bar card. For example, an encrypted transaction may occur between the contactless card and the device, which may configured to process one or more tap gestures. As explained above, the one or more applications may be configured to validate identity of the user and then cause the user to act or respond to it, for example, via one or more tap gestures. In some examples, data for example, bonus points, loyalty points, reward points, healthcare information, etc., may be written back to the contactless card.

In some examples, the contactless card may be tapped to a device, such as a mobile device. As explained above, identity of the user may be verified by the one or more applications which would then grant the user a desired benefit based on verification of the identity.

In some examples, the contactless card may be activated by tapping to a device, such as a mobile device. For example, the contactless card may communicate with an application of the device via a card reader of the device through NFC communication. The communication, in which a tap of the card proximate the card reader of the device may allow the application of the device to read data associated with the contactless card and activate the card. In some examples, the activation may authorize the card to be used to perform other functions, e.g., purchases, access account or restricted information, or other functions. In some examples, the tap may activate or launch the application of the device and then initiate one or more actions or communications with one or more servers to activate the contactless card. If the application is not installed on the device, a tap of the contactless card proximate the card reader may initiate a download of the application, such as navigation to a download page of the application). Subsequent to installation, a tap of the contactless card may activate or launch the application, and then initiate, for example via the application or other back-end communication), activation of the contactless card. After activation, the contactless card may be used in various activities, including without limitation commercial transactions.

In some embodiments, a dedicated application may be configured to execute on a client device to perform the activation of the contactless card. In other embodiments, a webportal, a web-based app, an applet, and/or the like may perform the activation. Activation may be performed on the client device, or the client device may merely act as a go between for the contactless card and an external device (e.g., account server). According to some embodiments, in providing activation, the application may indicate, to the account server, the type of device performing the activation (e.g., personal computer, smartphone, tablet, or point-of-sale (POS) device). Further, the application may output, for transmission, different and/or additional data to the account server depending on the type of device involved. For example, such data may comprise information associated with a merchant, such as merchant type, merchant ID, and information associated with the device type itself, such as POS data and POS ID.

In some embodiments, the example authentication communication protocol may mimic an offline dynamic data authentication protocol of the EMV standard that is commonly performed between a transaction card and a point-of-sale device, with some modifications. For example, because the example authentication protocol is not used to complete a payment transaction with a card issuer/payment processor per se, some data values are not needed, and authentication may be performed without involving real-time online connectivity to the card issuer/payment processor. As is known in the art, point of sale (POS) systems submit transactions including a transaction value to a card issuer. Whether the issuer approves or denies the transaction may be based on if the card issuer recognizes the transaction value. Meanwhile, in certain embodiments of the present disclosure, transactions originating from a mobile device lack the transaction value associated with the POS systems. Therefore, in some embodiments, a dummy transaction value (i.e., a value recognizable to the card issuer and sufficient to allow activation to occur) may be passed as part of the example authentication communication protocol. POS based transactions may also decline transactions based on the number of transaction attempts (e.g., transaction counter). A number of attempts beyond a buffer value may result in a soft decline; the soft decline requiring further verification before accepting the transaction. In some implementations, a buffer value for the transaction counter may be modified to avoid declining legitimate transactions.

In some examples, the contactless card can selectively communicate information depending upon the recipient device. Once tapped, the contactless card can recognize the device to which the tap is directed, and based on this recognition the contactless card can provide appropriate data for that device. This advantageously allows the contactless card to transmit only the information required to complete the instant action or transaction, such as a payment or card authentication. By limiting the transmission of data and avoiding the transmission of unnecessary data, both efficiency and data security can be improved. The recognition and selective communication of information can be applied to a various scenarios, including card activation, balance transfers, account access attempts, commercial transactions, and step-up fraud reduction.

If the contactless card tap is directed to a device running Apple's iOS® operating system, e.g., an iPhone, iPod, or iPad, the contactless card can recognize the iOS® operating system and transmit data appropriate data to communicate with this device. For example, the contactless card can provide the encrypted identity information necessary to authenticate the card using NDEF tags via, e.g., NFC. Similarly, if the contactless card tap is directed to a device running the Android® operating system, e.g., an Android® smartphone or tablet, the contactless card can recognize the Android® operating system and transmit appropriate and data to communicate with this device (such as the encrypted identity information necessary for authentication by the methods described herein).

As another example, the contactless card tap can be directed to a POS device, including without limitation a kiosk, a checkout register, a payment station, or other terminal. Upon performance of the tap, the contactless card can recognize the POS device and transmit only the information necessary for the action or transaction. For example, upon recognition of a POS device used to complete a commercial transaction, the contactless card can communicate payment information necessary to complete the transaction under the EMV standard.

In some examples, the POS devices participating in the transaction can require or specify additional information, e.g., device-specific information, location-specific information, and transaction-specific information, that is to be provided by the contactless card. For example, once the POS device receives a data communication from the contactless card, the POS device can recognize the contactless card and request the additional information necessary to complete an action or transaction.

In some examples the POS device can be affiliated with an authorized merchant or other entity familiar with certain contactless cards or accustomed to performing certain contactless card transactions. However, it is understood such an affiliation is not required for the performance of the described methods.

In some examples, such as a shopping store, grocery store, convenience store, or the like, the contactless card may be tapped to a mobile device without having to open an application, to indicate a desire or intent to utilize one or more of reward points, loyalty points, coupons, offers, or the like to cover one or more purchases. Thus, an intention behind the purchase is provided.

In some examples, the one or more applications may be configured to determine that it was launched via one or more tap gestures of the contactless card, such that a launch occurred at 3:51 pm, that a transaction was processed or took place at 3:56 pm, in order to verify identity of the user.

In some examples, the one or more applications may be configured to control one or more actions responsive to the one or more tap gestures. For example, the one or more actions may comprise collecting rewards, collecting points, determine the most important purchase, determine the least costly purchase, and/or reconfigure, in real-time, to another action.

In some examples, data may be collected on tap behaviors as biometric/gestural authentication. For example, a unique identifier that is cryptographically secure and not susceptible to interception may be transmitted to one or more backend services. The unique identifier may be configured to look up secondary information about individual. The secondary information may comprise personally identifiable information about the user. In some examples, the secondary information may be stored within the contactless card.

In some examples, the device may comprise an application that splits bills or check for payment amongst a plurality of individuals. For example, each individual may possess a contactless card, and may be customers of the same issuing financial institution, but it is not necessary. Each of these individuals may receive a push notification on their device, via the application, to split the purchase. Rather than accepting only one card tap to indicate payment, other contactless cards may be used. In some examples, individuals who have different financial institutions may possess contactless cards to provide information to initiate one or more payment requests from the card-tapping individual.

The following example use cases describe examples of particular implementations of the present disclosure. These are intended solely for explanatory purposes and not for purposes of limitation. In one case, a first friend (payor) owes a second friend (payee) a sum of money. Rather than going to an ATM or requiring exchange through a peer-to-peer application, payor wishes to pay via payee's smartphone (or other device) using a contactless card. Payee logs-on to the appropriate application on his smartphone and selects a payment request option. In response, the application requests authentication via payee's contactless card. For example, the application outputs a display requesting that payee tap his contactless card. Once payee taps his contactless card against the screen of his smartphone with the application enabled, the contactless card is read and verified. Next, the application displays a prompt for payor to tap his contactless card to send payment. After the payor taps his contactless card, the application reads the card information and transmits, via an associated processor, a request for payment to payor's card issuer. The card issuer processes the transaction and sends a status indicator of the transaction to the smartphone. The application then outputs for display the status indicator of the transaction.

In another example case, a credit card customer may receive a new credit card (or debit card, other payment card, or any other card requiring activation) in the mail. Rather than activating the card by calling a provided telephone number associated with the card issuer or visiting a website, the customer may decide to activate the card via an application on his or her device (e.g., a mobile device such as a smartphone). The customer may select the card activation feature from the application's menu that is displayed on a display of the device. The application may prompt the customer to tap his or her credit card against the screen. Upon tapping the credit card against the screen of the device, the application may be configured to communicate with a server, such as a card issuer server which activates the customer's card. The application may then displays a message indicating successful activation of the card. The card activation would then be complete.

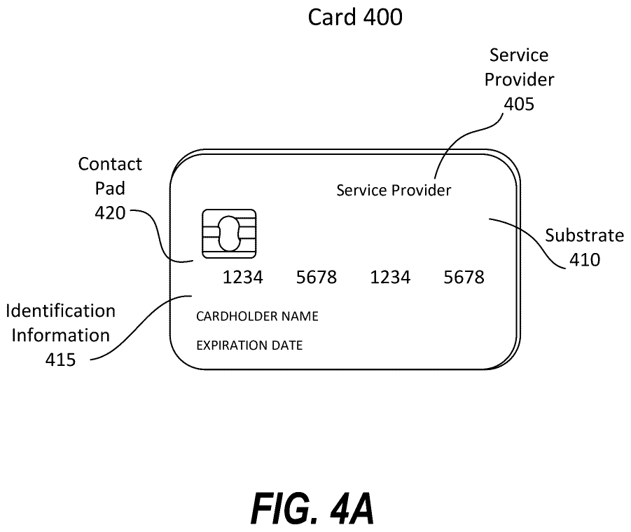

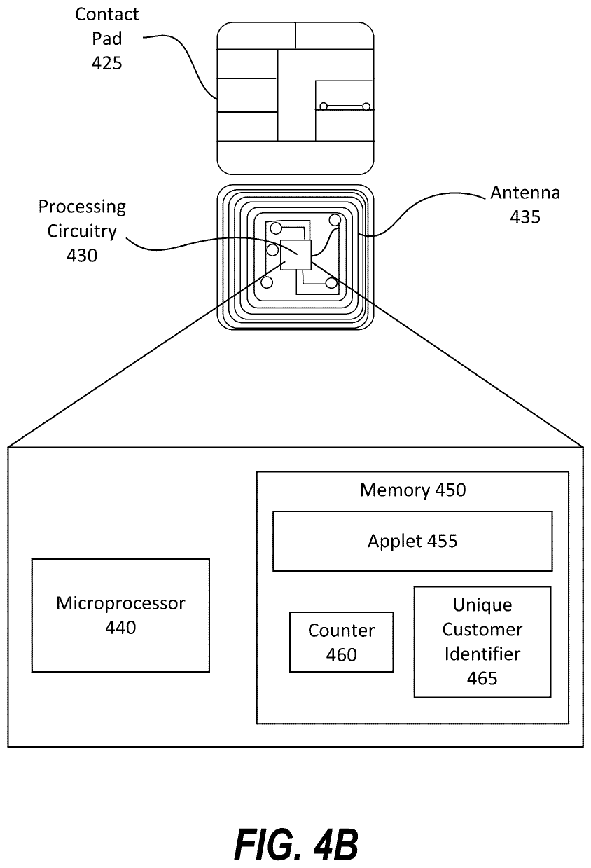

FIG. 4A illustrates a contactless card 400 according to an example embodiment. In some examples, the contactless card 400 may comprise a payment card, such as a credit card, debit card, or gift card, issued by a service provider 405 displayed on the front or back of the card 400. In some examples, the payment card may comprise a dual interface contactless payment card. In some examples, the contactless card 400 is not related to a payment card, and may comprise, without limitation, an identification card, a membership card, an access card, a transportation card, and an access card.

The contactless card 400 may comprise a substrate 410, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 400 may have physical characteristics compliant with the ID-1 format of the ISO/IEC 7810 standard, and the contactless card may otherwise be compliant with the ISO/IEC 14443 standard. However, it is understood that the contactless card 400 according to the present disclosure may have different characteristics, and the present disclosure does not require a contactless card to be implemented in a payment card.

The contactless card 400 may also include identification information 415 displayed on the front and/or back of the card, and a contact pad 420. The contact pad 420 may be configured to establish contact with another communication device, including but not limited to a user device, smart phone, laptop, desktop, or tablet computer. The contactless card 400 may also include processing circuitry, antenna and other components not shown in FIG. 4A. These components may be located behind the contact pad 420 or elsewhere on the substrate 410. The contactless card 400 may also include a magnetic strip or tape, which may be located on the back of the card (not shown in FIG. 4A).

FIG. 4B illustrates a contact pad of the contactless card according to an example embodiment. As shown in FIG. 4B, the contact pad 425 may include processing circuitry 430 for storing and processing information, including a microprocessor 440 and a memory 450. It is understood that the processing circuitry 430 may contain additional components, including processors, memories, error and parity/CRC checkers, data encoders, anticollision algorithms, controllers, command decoders, security primitives and tamperproofing hardware, as necessary to perform the functions described herein.

The memory 450 may be a read-only memory, write-once read-multiple memory or read/write memory, e.g., RAM, ROM, and EEPROM, and the contactless card 400 may include one or more of these memories. A read-only memory may be factory programmable as read-only or one-time programmable. One-time programmability provides the opportunity to write once then read many times. A write once/read-multiple memory may be programmed at a point in time. Once the memory is programmed, it may not be rewritten, but it may be read many times. A read/write memory may be programmed and re-programed many times after leaving the factory. It may also be read many times.

The memory 450 may be configured to store one or more applets 455, one or more counters 460, and a customer identifier 465. The one or more applets 455 may comprise one or more software applications configured to execute on one or more contactless cards, such as Java Card applet. However, it is understood that applets 455 are not limited to Java Card applets, and instead may be any software application operable on contactless cards or other devices having limited memory. The one or more counters 460 may comprise a numeric counter sufficient to store an integer. The customer identifier 465 may comprise a unique alphanumeric identifier assigned to a user of the contactless card 400, and the identifier may distinguish the user of the contactless card from other contactless card users. In some examples, the customer identifier 465 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 425 or entirely separate from it, or as further elements in addition to processor 440 and memory 450 elements located within the contact pad 425.

In some examples, the contactless card 400 may comprise one or more antennas 435. The one or more antennas 435 may be placed within the contactless card 400 and around the processing circuitry 430 of the contact pad 425. For example, the one or more antennas 435 may be integral with the processing circuitry 430 and the one or more antennas 435 may be used with an external booster coil. As another example, the one or more antennas 435 may be external to the contact pad 425 and the processing circuitry 430.

In an embodiment, the coil of contactless card 400 may act as the secondary of an air core transformer. The terminal may communicate with the contactless card 400 by cutting power or amplitude modulation. The contactless card 400 may infer the data transmitted from the terminal using the gaps in the contactless card's power connection, which may be functionally maintained through one or more capacitors. The contactless card 400 may communicate back by switching a load on the contactless card's coil or load modulation. Load modulation may be detected in the terminal's coil through interference.

As explained above, the contactless cards 400 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

FIG. 5 illustrates an exemplary client device side transaction limit process.

At step 505, the user can perform a one tap gesture, or other gesture with a transmitting device (e.g. a contactless card) to a receiving device (e.g. the user's client device). In some embodiments, a user may be logged into an application of the receiving device while performing the one tap gesture. The application can, for example, include an interface for facilitating a transaction limit bypass process and can instruct the user to perform a one tap gesture, or other gesture, with the user's transmitting device. The transaction limit bypass process interface can be one of a plurality of interfaces accessible within the application, and the user can navigate to the transaction limit bypass process upon opening the application. In another embodiment, the user can perform the one tap gesture when not logged into the application on their client device.

At step 510, the client device can display a prompt for seeking confirmation that the user wishes to bypass a transaction limit. In some embodiments, the prompt can be displayed with the application of the client device, in others, the prompt can be displayed in a dialog box in a manner which a user does not exit any existing applications opened on its phone which may or may not be associated with the contactless card or the user's issuer. In some embodiments, step 510 can be optional, and the user performing a one tap gesture, or other gesture, as described in connection with step 505, can cause the process to proceed to step 515 described herein without prompting the user for whether the user wishes to bypass a transaction limit.

At step 515, if the user indicates that they desire to bypass a transaction limit (such as by selecting a button displayed in the prompt associated with step 510), an application of the client device can transmit to an issuer server (associated with the contactless card) a transaction bypass request and location data. In embodiments where no prompt is displayed on the client device (as is described with respect to step 510), the application of the client device can transmit to the issuer server a transaction bypass request and location data.

Location data can be ascertained from a GPS module, or the like, of the client device via the client device application.

FIG. 6 illustrates an exemplary issuer server transaction limit process. At step 605, an issuer server (which can be associated with a user's contactless card), can receive a transaction limit request and a location data from a client device via a network, as described in connection with step 615 of FIG. 6.

At step 610 the issuer server can determine one or more merchants based on the location data. In some embodiments, a module of the issuer servant (such as the transaction limit bypass module 330 described in connection with FIG. 3), can compare the location data to merchant geofence data. Merchant geofence data can include an indication of the geographic boundary of each of a plurality of merchants. The transaction history of a user and/or the transaction histories of one or more similar users can also be considered in the merchant identification determination by the server to the extent that the merchant geofence data is unclear (such as when more than one merchant is associated with the location data of the client device). In some embodiments, the server can receive connection data (such as WiFi, and cellular connection data) from the client device, and can compare the received connection data to merchant connection data to aid in the determination of the one or more merchant. Merchant connection data can include any known network connections associated with each of a plurality of merchants.

At step 615 the issuer can transmit, to the client device, one or more merchants identified in step 610. In some embodiments, more than one merchant can be identified in step 610 such as, for example, when a user is shopping in a multi-story node, or in a busy city, and merchants are in close physical proximity to one another, and a client device's location data is not particularly precise. In such circumstances, a plurality of potential merchants can be identified by the server, and transmitted to the client device. The client device, can thereafter, display, each of the plurality of merchants on a display of the client device, and the user can select which one of the plurality of merchants it is attempting to exceed its transaction limit on. In scenarios where only one merchant is identified in step 610, the server can transmit to the client device, and cause the client device to display an indication of the merchant for the user to confirm. In some embodiments, the server can determine the merchant without receive any input from the user via the client device.

At step 620 the issuer server can receive, form the client device, a selection of one of the plurality of potential merchants transmitted to the client device in step 615.

At step 625, the issuer server can set a flag associated with the selected one or more merchant. In embodiments where the user does not select a particular merchant (and instead the server identifies a particular merchant based on the location data alone), a flag associated with the merchant identified by the server can be set. The flag can indicate that a transaction limit can be exceeded for the particular merchant.

At step 630 in FIG. 6, one or more flags can be evaluated. In some embodiments, a transaction limit bypass period can be determined for any flags which are set, which specifies the duration that the particular flag will remain set. In some embodiments, a transaction limit bypass period associated with a particular flag (and merchant) can be determined when an associated flag is initially set. In other embodiments, a transaction limit period for one or more merchants can be predefined, and stored in a database accessible to the server. The transaction limit bypass period can be determined by the parameters including, for example, user data and/or merchant data. User data can include, for example, data indicative of the time taken for a particular user to conduct a transaction once entering a store, or after having set a transaction limit bypass request. User data can also include user preferences set by the user as how long to allow a particular flag to be set after the user performs a transaction limit bypass request. The user can alter user preferences in, for example, an application associated with the issuer server. The application can be, for example, provided on the user's client device. Merchant data can include data indicative of an average time that a plurality of customers take to perform a certain transaction for a given merchant after request a transaction limit bypass request (by for example, the processes illustrated with respect to FIG. 5). In some embodiments, the transaction limit bypass period can be determined based on a predictive model. The predictive model can be trained using user data of similar users and/or merchant data.

At step 630 any flags which are current set can be evaluated based on associated transaction limit bypass periods. If a transaction limit bypass period associated with any of the set flags has lapsed (since the flag was initially set), the server can remove the flag.

In some embodiments, the setting of the flag can be removed after a transaction between the merchant associated with the flag and the user can been completed.

At step 635, the issuer server can determine a first transaction limit based on the parameters including user data and merchant data. The first transaction limit can be a normal transaction limit which is applied to a specific user when no flag is set for a particular merchant—i.e. when no request to bypass a transaction limit has been made by the user. The first transaction limit can vary by merchant and by user. In some embodiments, the first transaction limit can be predefined, and can be determined, for example, before any transaction request is received from the client device. In other embodiments, the first transaction limit can be determined when a transaction request is received.

User data can further include data indicative of previous transactions of the user (such as average transaction volume and transaction frequency of the user, whether the user typically transacts with a particular merchant, an amount of a typical transaction, and an amount of a typical transaction of a particular type of merchant) and other financial information of the user, such as a the user's credit score, account balance, annual salary, and other user specific metrics relevant a transaction limit. Merchant data can further include information pertaining to the average transaction amount for a typical merchant for a plurality of customers, fraudulent transaction amounts for a particular merchant, and the trustworthiness of the merchant. In some embodiments, a predictive model can be generated based on a machine learning model trained with user data of similar users, and/or merchant data. The predictive model can take, as an input, the user data and the merchant determined in, for example, step 620, and can determine a transaction limit based thereon.

At step 640 the issuer server can determine a second transaction limit. The second transaction limit can be greater than the first transaction limit. In some embodiments, the second transaction limit can be infinite, and the user can make a transaction for any transaction amount (to the extent that they have enough of a balance in their account). In other embodiments, the second transaction limit can be based on parameters including merchant data and user data. In particular, the second transaction limit can be determined based on, for example, a certain percentage of the account value of the user. In some embodiments, a predictive model can be utilized to determine the second transaction limit. The predictive model can be trained using user data of similar users, and/or merchant data as a training set. For example, the predictive model can determine an appropriate transaction amount by considering other similarly situated users, and a higher range of transaction amount for such users.

At step 645, transactions can be processed based on any flags that are set at the time of a transaction request is submitted. Transaction requests can be transmitted from a merchant payment system when a user utilizes their payment instrument to purchase goods or services. If a flag is set for merchant associated with a payment request, a transaction request exceeding the first transaction request limit can be authorized, but transaction having transaction amounts that exceed the second (higher) transaction limit will not be authorized. If no flag is set for the merchant associated with the payment request, the transaction request will not be authorized if the transaction amount exceeds the first transaction request.

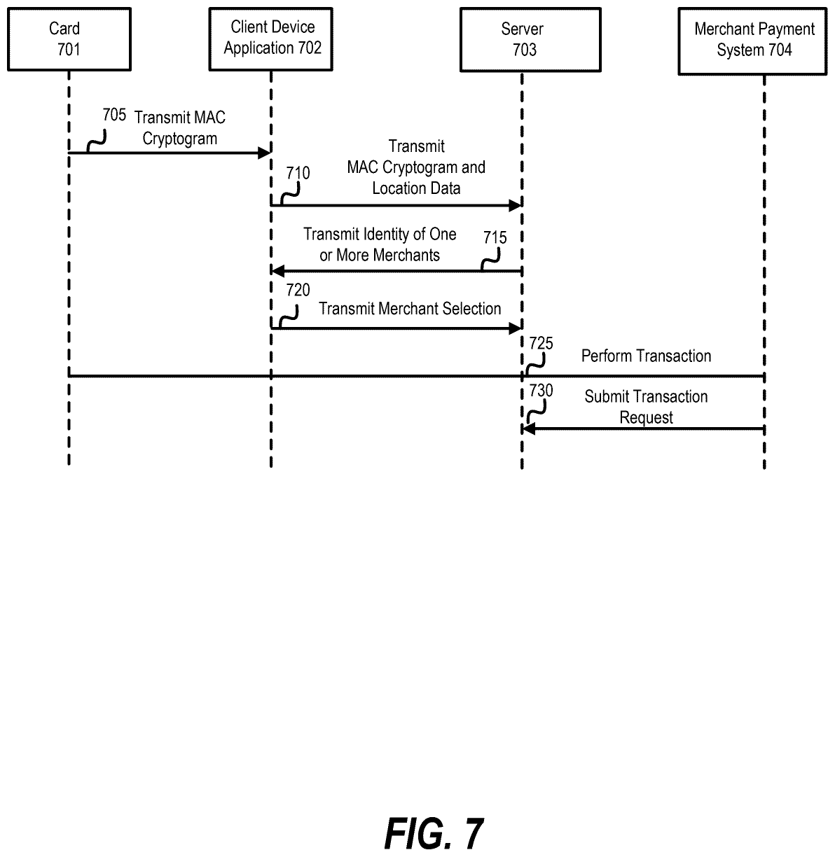

FIG. 7 is a sequence diagram illustrating sequences involved in an exemplary transaction limit bypass process described herein. FIG. 7 illustrates various interactions between a contactless card 701, a client device application 702 comprising instructions for execution on a client device, a server (e.g. an issuer server) 703, and a merchant payment system 704 described in exemplary embodiments herein.

At sequence step 705, the contactless card 701 can transmit a MAC cryptogram to the client device application 702 by, for example, a one tap gesture of the contactless card 701 to the client device application 702. The MAC cryptograph can be generated by the contactless card in accordance with the process described with respect to FIG. 2.

At sequence step 710, the client device application 702 can transmit the MAC cryptogram and location data of the client device to the server 703 via a network. The transmission of the MAC cryptograph by the client device application 702 to the server 703 is described with respect to FIG. 2. The location data of the client device, as described in connection with FIG. 5, can be, for example, the GPS coordinates to the client device when the client device application receives and/or transmits the MAC cryptogram from the contactless card 701.

At sequence step 715, after the issuer server 703 determines one or more merchants based on the location data received from sequence step 710, the issuer server can transmit the identity of the one or more determined merchants to the client device application 702, as described with respect to FIG. 6. Based on the merchant selection, the issuer server 703 can set a flag to indicate a first transaction limit can be exceeded by the user at the particular merchant. The issuer server 703 can determine the first transaction limit and a second transaction limit that cannot be exceeded, even if a flag for the merchant is set.

At sequence step 720, after the user selects one of the one or more identified merchants on the client device application 702, the client device application 702 can transmit the selection to the issuer server 703.

At sequence step 725 the user can utilize their contactless card 701 to pay for a goods or service at a particular merchant's merchant payment system 704. Merchant payment system 704 can be, for example, a POS device, or a kiosk.

At sequence step 730 the merchant payment system 704 can transmit a payment request to the issuer server 703 upon the user, for example, using their contactless card 701 to perform a transaction at the merchant payment system 704. The issuer server 703 can determine whether to approve the transaction request depending on whether the transaction amount exceeds the first transaction limit if no flag is set for the merchant, and the second transaction limit if a flag is set for the merchant.

In some examples, the present disclosure refers to a tap of the contactless card. However, it is understood that the present disclosure is not limited to a tap, and that the present disclosure includes other gestures (e.g., a wave or other movement of the card).

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A cryptographic bypass system, comprising:
a contactless card; and
a server, wherein the server is configured to:
receive a cryptogram and location data after a tap of the contactless card to a client device,
identify a first merchant based on location data,
set a flag associated with the first merchant and the contactless card,
receive a transaction request from a merchant payment system of the first merchant associated with the contactless card, wherein the transaction request indicates a transaction amount, and
approve the transaction request when the transaction amount exceeds a first transaction limit when the flag is set.

2. The cryptographic bypass system of claim 1, wherein the first merchant is identified based on a comparison of the location data to merchant geofence data.

3. The cryptographic bypass system of claim 2, wherein the merchant geofence data indicates a geographic boundary of the first merchant.

4. The cryptographic bypass system of claim 1, wherein the server is further configured to remove the setting of the flag after a predefined time.

5. The cryptographic bypass system of claim 1, wherein the server is further configured to remove the setting of the flag after completion of a transaction involving the first merchant and the contactless card.

6. The cryptographic bypass system of claim 1, wherein the server is further configured to determine the first transaction limit based on a predictive model.

7. The cryptographic bypass system of claim 1, wherein the server is further configured to determine a second transaction limit; and is configured to deny a transaction request including a transaction amount that exceeds the second transaction limit when the flag is set.

8. The cryptographic bypass system of claim 6, wherein the predictive model is trained from one or more parameters; wherein the one or more parameters includes at least one selected from a group of user data and merchant data.

9. The cryptographic bypass system of claim 1, wherein the server is further configured to transmit an identity of one or more merchants to the client device based on the location data.

10. The cryptographic bypass system of claim 9, wherein the server is further configured to determine the merchant based on a selection of one the one or more merchants.

11. A method of a cryptographic bypass, comprising:
receiving a cryptogram and location data transmitted from a client device after a tap of a contactless card to the client device;
identifying a first merchant based on location data;
setting a flag associated with the first merchant and the contactless card;
receiving a transaction request from a merchant payment system of the first merchant associated with the contactless card; wherein the transaction request indicates a transaction amount; and
approving the transaction request when the transaction amount exceeds a first transaction limit when the flag is set.

12. The method of claim 11, further comprising, removing the setting of the flag after a transaction limit bypass period has lapsed since the setting of the flag.

13. The method of claim 12 wherein the transaction limit bypass period is determined by a predictive model.

14. The method of claim 13, wherein:
the predictive model is trained from one or more parameters, and
the one or more parameters includes at least one selected from a group of user data and merchant data.

15. The method of claim 11, wherein the location data is derived from one of a GPS coordinates of the client device, or connection data of the client device.

16. The method of claim 11, further comprising:
determining a second transaction limit; and
denying a transaction request that includes a transaction amount exceeding the second transaction limit when the flag is set.

17. The method of claim 16, wherein the second transaction limit is determined based on a predictive model.

18. The method of claim 17, wherein the predictive model is trained from one or more parameters; wherein the one or more parameters includes at least one selected from a group of user data and merchant data.

19. The method of claim 11, further comprising transmitting an identity of one or more merchants to the client device based on the location data.

20. A computer readable non-transitory medium comprising computer executable instructions that, when executed on a processor, configure the processor to perform procedures comprising:
receiving a cryptogram and location data transmitted from a client device after a tap of a contactless card to the client device;
identifying a first merchant based on location data;
setting a flag associated with the first merchant and the contactless card;
receiving a transaction request from a merchant payment system of the first merchant associated with the contactless card, wherein the transaction request indicates a transaction amount; and
approving the transaction request when the transaction amount exceeds a first transaction limit when the flag is set.
